(19) United States
(12) Patent Application Publication
(10) Pub. No.: US 2009/0261194 A1
(43) Pub. Date: Oct. 22, 2009

(54) Winding apparatus and winding method

(75) Inventor: Keiji Naitou, Echizen-shi (JP)

Correspondence Address: RABIN & Berdo, PC, 1101 14TH STREET, NW, SUITE 500, WASHINGTON, DC, 20005, US

(73) Assignee: Nittoku Engineering Co., Ltd., Saitama (JP)

(21) Appl. No.: 12/081,491

(22) Filed: Apr. 16, 2008

(51) Int. Cl. H02K 15/04

(52) U.S. Cl. 242/432

(57) ABSTRACT

A winding apparatus includes a head 12 that supports a nozzle 11; a head support shaft 13 that supports the head 12; a traverse shaft 14 that rotates about an axial center independently of the head support shaft 13 and is connected to the head support shaft 13 in an axial direction; a shaft connecting device 15 that connects the two shafts 13, 14 such that when the head support shaft 13 rotates about the axial center, the rotation thereof is transmitted to the traverse shaft 14, but when the traverse shaft 14 rotates about the axial center, the rotation thereof is not transmitted to the head support shaft 13; a head rotating mechanism 16 that rotates the head 12 about the axial center by rotating the head support shaft 13 such that the traverse shaft 14 rotates in synchronization with the head support shaft 13; a nozzle moving mechanism 18 that moves the nozzle 11 in an axial diametrical direction by rotating the traverse shaft 14 such that the traverse shaft 14 rotates relative to the head support shaft 13; and a head moving mechanism 17 that moves the head 12 in the axial direction by moving the two shafts 13, 14 in the axial direction.

### TECHNICAL FIELD OF THE INVENTION

This invention relates to a winding apparatus and a winding method, and more particularly to a winding apparatus and a winding method for manufacturing a stator coil.

### DESCRIPTION OF RELATED ART

JP2002-208530A discloses a winding apparatus for manufacturing a stator coil.

The winding apparatus described in JP2002-208530A comprises a head supporting shaft that rotates a head supporting a nozzle, a traverse shaft that rotates relative to the head support shaft, shaft rotating motors that rotate the respective shafts, a guide plate provided on an end portion of the head support shaft, a cam plate provided on an end portion of the traverse shaft, and a nozzle holder having a sliding portion that engages slidably with a guide groove in the guide plate and a cam follower that engages with a cam groove in the cam plate.

In this winding apparatus, when the respective shaft rotating motors are rotated at an identical speed, the head support shaft and the traverse shaft rotate together, and the nozzle rotates in a circumferential direction of the stator.

Further, when the respective shaft rotating motors are rotated at different speeds, the cam plate on the end portion of the traverse shaft rotates relative to the guide plate on the end portion of the head support shaft, and the nozzle holder moves in a diametrical direction of the stator. Hence, by rotating the respective shaft rotating motors at different speeds, a wire is fed.

### SUMMARY OF THE INVENTION

However, in the winding apparatus described in JP2002-208530A, the two shaft rotating motors must be rotated at the same speed to rotate the nozzle in the circumferential direction of the stator, but when the speeds of the two shaft rotating motors are even slightly different, the nozzle moves in the diametrical direction of the stator. In this case, stable winding cannot be performed on the poles of the stator.

Furthermore, to move the nozzle in the diametrical direction of the stator, the two shaft rotating motors must be rotated at different speeds, and therefore, when the head support shaft rotates at a high speed, it may become necessary to rotate the traverse shaft at an even higher speed. In this case, the shaft rotating motor of the traverse shaft may become unable to keep up with the rotation speed of the head support shaft, and as a result, stable winding cannot be performed on the poles of the stator.

This invention has been designed in consideration of the problems described above, and it is an object thereof to provide a winding apparatus and a winding method with which stable winding can be performed.

In order to achieve above object, this invention provides a winding apparatus that winds a wire onto a pole. The winding apparatus comprises a nozzle that unreels the wire, a nozzle support member that supports the nozzle such that the nozzle is oriented in a longitudinal direction of the pole, a first shaft that supports the nozzle support member, a second shaft that is disposed coaxially with the first shaft, rotates about an axial center independently of the first shaft, and is connected to the first shaft in an axial direction, a nozzle moving plate that is coupled to the second shaft and moves the nozzle in an axial diametrical direction by rotating relative to the nozzle support member, a shaft connecting device that connects the second shaft to the first shaft such that when the first shaft rotates about the axial center, a rotation thereof is transmitted to the second shaft, but when the second shaft rotates about the axial center, a rotation thereof is not transmitted to the first shaft, a rotating device that rotates the nozzle support member about the axial center by rotating the first shaft such that the second shaft rotates in synchronization with the first shaft, a diametrical direction moving device that moves the nozzle in the axial diametrical direction by rotating the second shaft such that the second shaft rotates relative to the first shaft, and a axial direction moving device that moves the nozzle support member in the axial direction by moving the first shaft and the second shaft in the axial direction.

### BRIEF DESCRIPTION OF THE DRAWINGS

FIG. 1 is a perspective view showing the periphery of a stator in a winding apparatus according to an embodiment of this invention.

FIG. 2 is a perspective view showing the winding apparatus according to an embodiment of this invention.

FIG. 3 is a sectional view showing the winding apparatus according to an embodiment of this invention.

### PREFERRED EMBODIMENTS OF THE INVENTION

An embodiment of this invention will be described below with reference to the figures.

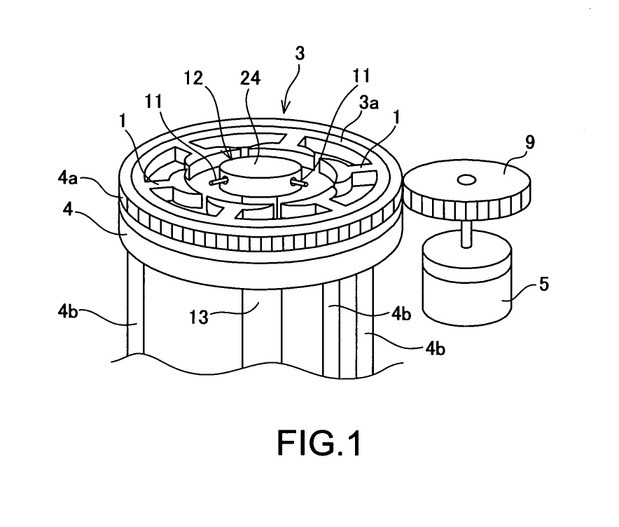

Referring to FIGS. 1 to 3, a winding apparatus 100 according to an embodiment of this invention will be described.

The winding apparatus 100 is an apparatus that automatically winds a wire 2 around a pole 1. In this embodiment, an apparatus that winds the wire 2 around the pole 1 of a stator 3 in an inner rotor-type motor will be described.

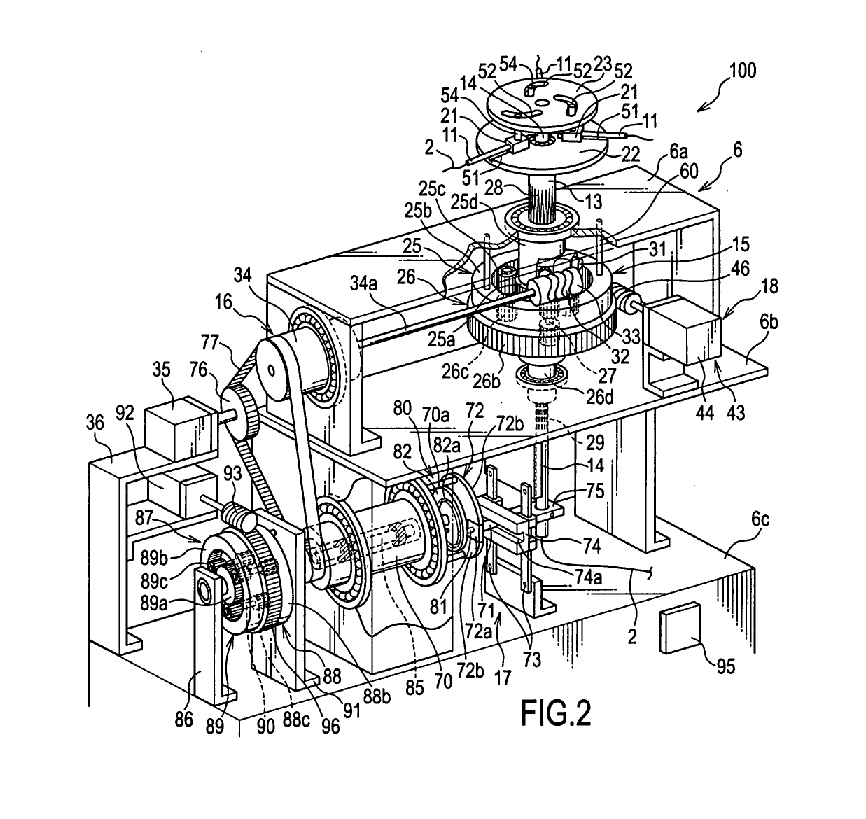

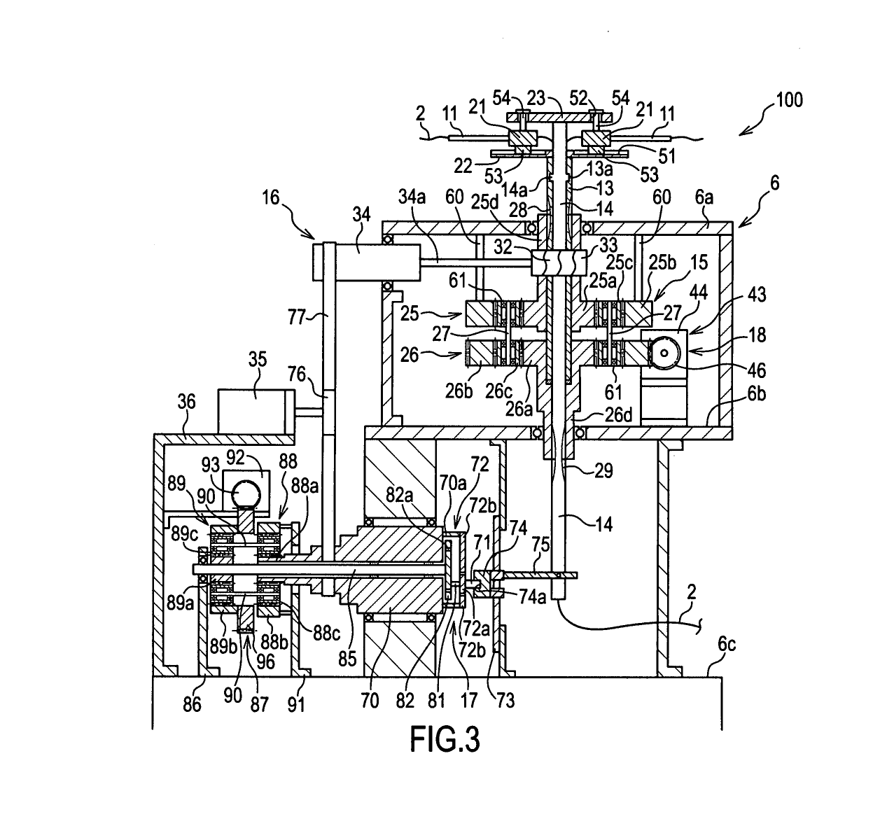

As shown in FIG. 1, the stator 3 is supported on a stator support base 4, and the stator support base 4 is driven to rotate by an index motor 5. The stator support base 4 is disposed on an upper step 6a (see FIG. 2) of a frame 6 via a strut 4b, and the index motor 5 is also disposed on the upper step 6a. It should be noted that the stator 3, stator support base 4, and index motor 5 are not shown in FIGS. 2 and 3.

The stator 3 comprises a ring-shaped yoke portion 3a and a plurality of poles 1 that extend from the inner periphery of the yoke portion 3a toward the center of the stator 3. The wire 2 is wound around each pole 1 to form a stator coil.

The stator support base 4 has teeth 4a on its outer periphery, which mesh with a gear 9 connected to an output shaft of the index motor 5, and is rotated by driving the index motor 5.

As shown in FIGS. 2 and 3, the winding apparatus 100 comprises a plurality of nozzles 11 that unreel the wire 2, a head 12 (see FIG. 1) serving as a nozzle support member that supports the plurality of nozzles 11, a head support shaft 13 serving as a first shaft that supports the head 12, a traverse shaft 14 serving as a second shaft disposed coaxially with the head support shaft 13, a shaft connecting device 15 that connect the traverse shaft 14 to the head support shaft 13, a head rotating mechanism 16 serving as rotating device that rotate the head 12 about the axial center of the head support shaft 13, a head moving mechanism 17 serving as axial direction moving device that move the head 12 in the axial direction of the head support shaft 13, and a nozzle moving mechanism 18 serving as diametrical direction moving device that move the nozzle 11 in the diametrical direction of the head support shaft 13.

The winding apparatus 100 drives the head rotating mechanism 16, head moving mechanism 17, and nozzle moving mechanism 18 to move the nozzle 11 around the pole 1 such that the wire 2 that is unreeled from the nozzle 11 is wound around the pole 1. The constitution of the winding apparatus 100 will be described in detail below.

The nozzles 11 are held by a nozzle holder 21 and disposed in a radial form extending in the longitudinal direction of the poles 1 of the stator 3.

The head 12 is disposed in an inside opening portion of the stator 3. The head 12 comprises a disk-shaped guide plate 22 disposed concentrically with the stator 3 and a lid member 24 (see FIG. 1) covering the guide plate 22. The nozzle holder 21 is supported by the guide plate 22. It should be noted that in FIGS. 2 and 3, the head 12 is shown with the lid member 24 removed.

The head support shaft 13 takes a cylindrical shape, a tip end of which is coupled to the center of the guide plate 22 of the head 12. Hence, when the head support shaft 13 rotates about its axial center, the head 12 rotates with the head support shaft 13 as the central axis.

The traverse shaft 14 takes a cylindrical shape, and is disposed so as to penetrate a hollow portion of the head support shaft 13.

A plurality of the wires 2 supplied from a wire supply source (not shown) are led from a base end of the traverse shaft 14 into a hollow portion of the traverse shaft 14, withdrawn from an opening portion provided near the head 12, and held in the nozzles 11.

The head support shaft 13 and traverse shaft 14 are connected by engaging a ring-shaped groove 13a provided on the inner periphery of the head support shaft 13 and a ring-shaped projecting portion 14a provided on the outer periphery of the traverse shaft 14. Thus, the head support shaft 13 and traverse shaft 14 rotate independently about their respective axial centers and are connected in the axial direction.

A tip end of the traverse shaft 14 is coupled to the center of a disk-shaped cam plate 23 serving as a nozzle moving plate. Hence, when the traverse shaft 14 rotates about its axial center, the cam plate 23 rotates with the traverse shaft 14 as the central axis.

The cam plate 23 is disposed on the opposite side of the nozzle holder 21 to the guide plate 22 and parallel with the guide plate 22. The guide plate 22 and cam plate 23 are constituted such that when the cam plate 23 rotates relative to the guide plate 22, the nozzle 11 moves in the diametrical direction of the head support shaft 13.

Referring to FIG. 2, a specific mechanism enabling the nozzle 11 to move in the diametrical direction of the head support shaft 13 will be described. Guide grooves 51 extending radially from the center in a diametrical direction are formed in the guide plate 22. The guide grooves 51 are formed in an equal number to the number of nozzles 11. Cam grooves 52 extending in a swirl shape from the vicinity of the center in an outer edge direction are formed in the cam plate 23 in positions corresponding to the guide grooves 51 of the guide plate 22.

The nozzle holder 21 that holds the nozzle 11 comprises a sliding portion 53 that engages slidably with the guide groove 51 of the guide plate 22, and a roller-shaped cam follower 54 that engages with the cam groove 52 of the cam plate 23. Hence, when the cam plate 23 rotates relative to the guide plate 22, the cam follower 54 moves along the swirl-shaped cam groove 52, whereby the nozzle holder 21 moves along the guide groove 51 in the diametrical direction of the guide plate 22, or in other words the diametrical direction of the head support shaft 13.

Therefore, by rotating the traverse shaft 14 relative to the head support shaft 13, the nozzle 11 moves in the diametrical direction of the head support shaft 13, or in other words the longitudinal direction of the pole 1. In contrast, by rotating the traverse shaft 14 and the head support shaft 13 synchronously, or in other words at the same speed, the nozzle 11 moves in a width direction of the pole 1 rather than the diametrical direction of the head support shaft 13.

Next, the shaft connecting device 15 that connects the traverse shaft 14 to the head support shaft 13 will be described.

The shaft connecting device 15 comprises a first gear mechanism 25 connected to the head support shaft 13, a second gear mechanism 26 connected to the traverse shaft 14, and a connecting shaft 27 serving as a connecting member that connects the second gear mechanism 26 to the first gear mechanism 25.

The first gear mechanism 25 comprises a sun gear 25a having teeth formed on its outer periphery, a ring-shaped internal gear 25b surrounding the sun gear 25a and having teeth formed on its inner periphery, and a plurality of planetary gears 25c disposed between the sun gear 25a and internal gear 25b and having teeth formed on their respective outer peripheries, which mesh with the teeth of both the sun gear 25a and the internal gear 25b.

A cylindrical portion 25d is coupled to the sun gear 25a. The head support shaft 13 penetrates the sun gear 25a and the cylindrical portion 25d, and is coupled to the inner periphery of the cylindrical portion 25d via a spline 28 formed on its outer periphery. Thus, the head support shaft 13 is spline-coupled to the sun gear 25a via the cylindrical portion 25d so as to be capable of moving in an axial direction relative to the sun gear 25a and cylindrical portion 25d.

The internal gear 25b is fixed non-rotatably to the upper step 6a of the frame 6 by a rod 60.

The second gear mechanism 26 comprises a sun gear 26a having teeth formed on its outer periphery, a ring-shaped internal gear 26b surrounding the sun gear 26a and having teeth formed on its inner periphery, and a plurality of planetary gears 26c disposed between the sun gear 26a and internal gear 26b and having teeth formed on their respective outer peripheries, which mesh with the teeth of both the sun gear 26a and the internal gear 26b.

A cylindrical portion 26d is coupled to the sun gear 26a. The traverse shaft 14 penetrates the sun gear 26a and the cylindrical portion 26d, and is coupled to the inner periphery of the cylindrical portion 26d via a spline 29 formed on its outer periphery. Thus, the traverse shaft 14 is spline-coupled to the sun gear 26a via the cylindrical portion 26d so as to be capable of moving in an axial direction relative to the sun gear 26a and cylindrical portion 26d.

The connecting shaft 27 penetrates both the planetary gear 25c of the first gear mechanism 25 and the planetary gear 26c of the second gear mechanism 26 via a bearing 61 so as to connect the planetary gears 25c, 26c. Thus, the planetary gear 25c and the planetary gear 26c are capable of revolving synchronously around the sun gear 25a and the sun gear 26a, and are also capable of independent self-rotation.

By constituting the shaft connecting device 15 in this manner, when the sun gear 25a of the first gear mechanism 25 is rotated, the head support shaft 13, which is spline-coupled to the inner periphery of the sun gear 25a, rotates about the axial center. Furthermore, the internal gear 25b is fixed, and therefore the planetary gear 25c revolves around the inner periphery of the internal gear 25b while self-rotating.

When the planetary gear 25c of the first gear mechanism 25 revolves, the planetary gear 26c of the second gear mechanism 26, which is connected to the planetary gear 25c by the connecting shaft 27, revolves around the inner periphery of the internal gear 26b while self-rotating. As a result, the sun gear 26a rotates, and the traverse shaft 14, which is spline-coupled to the inner periphery of the sun gear 26a, rotates about the axial center. Thus, the rotation of the first gear mechanism 25 is transmitted to the second gear mechanism 26. At this time, the internal gear 26b of the second gear mechanism 26 remains in a non-rotating stationary state.

Further, when the internal gear 26b of the second gear mechanism 26 is rotated, the planetary gear 26c self-rotates such that the sun gear 26a rotates. As a result, the traverse shaft 14, which is spline-coupled to the inner periphery of the sun gear 26a, rotates about the axial center. At this time, both the internal gear 26b and the sun gear 26a rotate, and therefore the planetary gear 26c does not revolve around the inner periphery of the internal gear 26b, only self-rotating around the connecting shaft 27 at the same position. Accordingly, the rotation of the second gear mechanism 26 is not transmitted to the first gear mechanism 25.

As described above, the shaft connecting device 15 is capable of rotating the traverse shaft 14 about the axial center in synchronization with the head support shaft 13 by rotating the sun gear 25a of the first gear mechanism 25 such that the head support shaft 13 rotates about the axial center. The shaft connecting device 15 is also capable of rotating the traverse shaft 14 relative to the head support shaft 13 by rotating the internal gear 26b of the second gear mechanism 26 such that the traverse shaft 14 rotates about the axial center.

Next, the head rotating mechanism 16 will be described.

The head rotating mechanism 16 comprises a winding motor 35, a first rotary shaft 34 to which the rotation of the winding motor 35 is transmitted, an output shaft 34a coupled to the first rotary shaft 34, a roller cam 33 coupled to a tip end of the output shaft 34a and having a wave-shaped cam groove 32 on its outer peripheral surface, and a cam follower 31 that is coupled to the cylindrical portion 25d of the first gear mechanism 25 and guided through the cam groove 32 of the roller cam 33.

The winding motor 35 is supported on a motor support base 36 disposed on a lower step 6c of the frame 6.

The cam groove 32 of the roller cam 33 is formed in such a shape that the guided cam follower 31 oscillates about the axial center of the head support shaft 13.

By rotating the winding motor 35, the rotation thereof is transmitted to the first rotary shaft 34, and as a result, the roller cam 33 on the tip end of the output shaft 34a rotates. The cam follower 31 oscillates to be guided along the cam groove 32 of the rotating roller cam 33. Hence, the head support shaft 13, which is spline-coupled to the sun gear 25a, oscillates (rotates in a reciprocating manner) about the axial center such that the head 12 on the tip end of the head support shaft 13 also oscillates about the axial center. At this time, the traverse shaft 14 oscillates about the axial center in synchronization with the head support shaft 13 due to the action of the shaft connecting device 15, and therefore the nozzle 11 oscillates in the width direction of the pole 1.

Next, the nozzle moving mechanism 18 will be described.

The nozzle moving mechanism 18 comprises a traverse shaft rotating mechanism 43 that rotates the traverse shaft 14 in addition to the nozzle holder 21, guide plate 22, and cam plate 23 which enable the nozzle 11 to move in the diametrical direction of the head support shaft 13.

The traverse shaft rotating mechanism 43 comprises a traverse shaft rotation motor 44 disposed on a middle step 6b of the frame 6, and a worm gear 46 connected to an output shaft of the traverse shaft rotation motor 44. The worm gear 46 meshes with teeth formed on the outer peripheral surface of the internal gear 26b of the second gear mechanism 26.

By rotating the traverse shaft rotation motor 44, the rotation thereof is transmitted to the internal gear 26b of the second gear mechanism 26 via the worm gear 46 such that the internal gear 26b rotates. As a result, the planetary gear 26c self-rotates, and the sun gear 26a rotates. Accordingly, the traverse shaft 14, which is spline-coupled to the sun gear 26a, rotates about the axial center. At this time, the planetary gear 26c does not revolve, and therefore the rotation of the second gear mechanism 26 is not transmitted to the first gear mechanism 25. Hence, the traverse shaft 14 rotates relative to the head support shaft 13 such that the nozzle 11 moves in the diametrical direction of the head support shaft 13.

It should be noted that the rotation of the traverse shaft rotation motor 44 may be transmitted to the internal gear 26b using a pulley and a belt in place of the worm gear 46.

Next, the head moving mechanism 17 will be described.

The head moving mechanism 17 comprises a second rotary shaft 70 to which the rotation of the winding motor 35 is transmitted, a substantially disk-shaped rotating plate 72 that is coupled to a tip end of the second rotary shaft 70 via a rod 70a and has a first cam follower 71 on its outer edge, a pair of guide rails 73 extending in the axial direction of the head support shaft 13, and a moving plate 74 that is capable of moving along the guide rails 73.

The moving plate 74 is connected to a base end side of the traverse shaft 14 via a relay plate 75. Further, a cam groove 74a extending in an orthogonal direction to the guide rails 73, through which the first cam follower 71 is guided, is formed on the moving plate 74.

By rotating the winding motor 35, the rotation thereof is transmitted to the second rotary shaft 70 such that the rotary plate 72 on the tip end of the second rotary shaft 70 rotates. As the rotary plate 72 rotates, the first cam follower 71 rotates about the rotary axis of the rotary plate 72. At this time, the first cam follower 71 rotates while moving along the cam groove 74a of the moving plate 74. As a result, the moving plate 74 reciprocates along the guide rails 73 such that the traverse shaft 14, which is connected to the moving plate 74, also reciprocates in the axial direction.

The traverse shaft 14 and the head support shaft 13 are connected in the axial direction, and therefore the two shafts 14, 13 reciprocate integrally in the axial direction. Accordingly, the head 12 reciprocates in the axial direction, and the nozzle 11 reciprocates in the height direction of the pole 1.

As described above, oscillation of the nozzle 11 in the width direction of the pole 1 and reciprocation of the nozzle 11 in the height direction of the pole 1 are performed by the same winding motor 35. In other words, by driving the winding motor 35, the nozzle 11 gyrates about the pole 1. More specifically, the nozzle 11 gyrates in an arc-shaped trajectory around the pole 1.

A pulley 76 is coupled to the output shaft of the winding motor 35, and the pulley 76, the first rotary shaft 34, and the second rotary shaft 70 are connected by a belt 77. Hence, the rotation of the winding motor 35 is transmitted to the first rotary shaft 34 and the second rotary shaft 70 via the pulley 76 and the belt 77.

The first rotary shaft 34 and second rotary shaft 70 may be rotated by separate motors. In other words, a rotation motor for causing the nozzle 11 to oscillate in the width direction of the pole 1 and an axial direction movement motor for causing the nozzle 11 to reciprocate in the height direction of the pole 1 may be provided instead of the winding motor 35. In so doing, the gyration trajectory of the nozzle 11 can be set more freely. For example, the nozzle 11 can easily be caused to gyrate in a quadrate trajectory around the pole 1.

The head moving mechanism 17 further comprises a mechanism that varies the reciprocation stroke of the nozzle 11 in the height direction of the pole 1. This mechanism will now be described.

The rotary plate 72 comprises a sliding plate 72a that is capable of moving in the diametrical direction of the rotary plate 72, and a pair of guide plates 72b that are coupled to a tip end of the second rotary shaft 70 in order to guide the sliding plate 72a.

The first cam follower 71 is coupled to one surface of the sliding plate 72a. Hence, when the sliding plate 72a moves in the diametrical direction of the rotary plate 72 along the guide plates 72b such that the position of the sliding plate 72a changes, the rotation radius of the first cam follower 71 varies.

By varying the rotation radius of the first cam follower 71, the reciprocation stroke of the moving plate 74 along the guide rails 73 varies, and as a result, the reciprocation stroke of the head 12 in the axial direction also varies. Accordingly, the reciprocation stroke of the nozzle 11 in the height direction of the pole 1 varies.

More specifically, when the sliding plate 72a moves toward a rotary center of the rotary plate 72, the rotation radius of the first cam follower 71 decreases, and as a result, the reciprocation stroke of the moving plate 74 along the guide rails 73 decreases. Accordingly, the reciprocation stroke of the nozzle 11 in the height direction of the pole 1 also decreases.

Further, when the sliding plate 72a moves in a direction heading away from the rotary center of the rotary plate 72, the rotation radius of the first cam follower 71 increases, and as a result, the reciprocation stroke of the moving plate 74 along the guide rails 73 increases. Accordingly, the reciprocation stroke of the nozzle 11 in the height direction of the pole 1 also increases.

Next, rotation radius modifying device 80 that modify the rotation radius of the first cam follower 71 by varying the position of the sliding plate 72a will be described.

The rotation radius modifying device 80 comprise a second cam follower 81 coupled to a surface of the sliding plate 72a on the opposite side of the surface to which the first cam follower 71 is coupled, and a cam plate 82 that is disposed between the tip end surface of the second rotary shaft 70 and the rotary plate 72 so as to be capable of rotating concentrically with the rotary plate 72.

The cam plate 82 is formed with a cam groove 82a that extends in a swirl shape from the vicinity of the center in an outer edge direction. The second cam follower 81 engages with the cam groove 82a. Thus, when the cam plate 82 rotates relative to the rotary plate 72, the second cam follower 81 is guided through the cam groove 82a of the cam plate 82 such that the position of the sliding plate 72a varies.

Hence, by rotating the cam plate 82 relative to the rotary plate 72 in this manner, the position of the sliding plate 72a varies, and as a result, the rotation radius of the first cam follower 71 is modified. In contrast, when the cam plate 82 and the rotary plate 72 are rotated synchronously, or in other words at the same speed, the position of the sliding plate 72a does not vary, and the rotation radius of the first cam follower 71 does not change.

A variable stroke shaft 85 is coupled to the rotary center of the cam plate 82. The variable stroke shaft 85 penetrates a hollow portion of the second rotary shaft 70, and a base end side thereof is supported by a support plate 86 so as to be free to rotate. Thus, the second rotary shaft 70 and the variable stroke shaft 85 are disposed coaxially.

The second rotary shaft 70 and variable stroke shaft 85 are connected by a shaft connecting device 87 serving as shaft connecting device such that when the second rotary shaft 70 rotates about its axial center, the rotation thereof is transmitted to the variable stroke shaft 85, but when the variable stroke shaft 85 rotates about its axial center, the rotation thereof is not transmitted to the second rotary shaft 70.

Next, the shaft connecting device 87 will be described. The constitution of the shaft connecting device 87 is similar to the constitution of the shaft connecting device 15 described above, and therefore only a brief description will be provided.

The shaft connecting device 87 comprises a first gear mechanism 88 connected to the second rotary shaft 70, a second gear mechanism 89 connected to the variable stroke shaft 85, and a connecting shaft 90 serving as a connecting member that connects the second gear mechanism 89 to the first gear mechanism 88.

The first gear mechanism 88 comprises a sun gear 88a that is coupled integrally to a base end side of the second rotary shaft 70, a ring-shaped internal gear 88b that surrounds the sun gear 88a and is fixed non-rotatably, and a plurality of planetary gears 88c that are disposed between the sun gear 88a and the internal gear 88b and mesh with both.

The internal gear 88b is fixed non-rotatably to a support plate 91 that supports the second rotary shaft 70 rotatably.

The second gear mechanism 89 comprises a sun gear 89a that is coupled integrally to a base end side of the variable stroke shaft 85, a ring-shaped internal gear 89b that surrounds the sun gear 89a, and a plurality of planetary gears 89c that are disposed between the sun gear 89a and the internal gear 89b and mesh with both.

The connecting shaft 90 penetrates both the planetary gear 88c of the first gear mechanism 88 and the planetary gear 89c of the second gear mechanism 89 via a bearing 94 so as to connect the planetary gears 88c, 89c. Thus, the planetary gear 88c and the planetary gear 89c are capable of revolving synchronously around the sun gear 88a and the sun gear 89a, and are also capable of independent self-rotation.

A variable stroke motor 92 is disposed on the motor support base 36, and a worm gear 93 is connected to an output shaft of the variable stroke motor 92. The worm gear 93 meshes with a ring-shaped gear 96 coupled to the internal gear 89b of the second gear mechanism 89.

By constituting the shaft connecting device 87 in this manner, when the winding motor 35 rotates, the second rotary shaft 70, which is connected thereto via the belt 77, rotates about the axial center. When the second rotary shaft 70 rotates, the sun gear 88a of the first gear mechanism 88 rotates. The internal gear 88b is fixed, and therefore the planetary gear 88c revolves around the inner periphery of the internal gear 88b while self-rotating.

When the planetary gear 88c of the first gear mechanism 88 revolves, the planetary gear 89c of the second gear mechanism 89, which is connected to the planetary gear 88c by the connecting shaft 90, revolves around the inner periphery of the internal gear 89b while self-rotating. As a result, the sun gear 89a rotates, and the variable stroke shaft 85 rotates about the axial center. At this time, the internal gear 89b remains in a non-rotating stationary state.

Thus, the rotation of the second rotary shaft 70 is transmitted to the variable stroke shaft 85 such that the second rotary shaft 70 and variable stroke shaft 85 rotate synchronously. As a result, the cam plate 82 and the rotary plate 72 also rotate synchronously, and therefore the head 12 reciprocates in the axial direction in a stroke set according to the relative positions of the cam plate 82 and rotary plate 72.

Further, when the variable stroke motor 92 rotates, the rotation thereof is transmitted to the internal gear 89b of the second gear mechanism 89 via the worm gear 93 and the ring-shaped gear 96 such that the internal gear 89b rotates. When the internal gear 89b rotates, the planetary gear 89c self-rotates and the sun gear 89a rotates. As a result, the variable stroke shaft 85 rotates about the axial center. At this time, both the internal gear 89b and the sun gear 89a rotate, and therefore the planetary gear 89c does not revolve.

Hence, the rotation of the variable stroke shaft 85 is not transmitted to the second rotary shaft 70, and therefore the variable stroke shaft 85 rotates relative to the second rotary shaft 70. As a result, the cam plate 82 rotates relative to the rotary plate 72, and therefore the rotation radius of the first cam follower 71 varies, leading to a variation in the reciprocation stroke of the head 12 in the axial direction.

As another constitution of the head moving mechanism 17, the head 12 may be caused to reciprocate in the axial direction using a crank mechanism. Alternatively, the head 12 may be caused to reciprocate in the axial direction using a motor and a ball screw.

Next, a winding operation of the winding apparatus 100 will be described. The winding operation is controlled by a controller 95 installed in the winding apparatus 100.

First, the stator 3 is fixed to the stator support base 4, whereupon the index motor 5 is driven to position the stator 3 such that the respective poles 1 face the nozzles 11.

A plurality of the wires 2 supplied from the wire supply source are led into the hollow portion of the traverse shaft 14 from the base end thereof and withdrawn through the opening portion provided near the head 12. The wires 2 are then passed through the respective nozzles 11 and withdrawn from the tip end of the nozzles 11. The wire 2 withdrawn from the tip end of the nozzle 11 is held by a clamp (not shown).

The winding apparatus 100 comprises a plurality of the nozzles 11, and therefore winding is performed onto a plurality of the poles 1 simultaneously. The wire 2 is wound onto the pole 1 by a combination of an operation to move the nozzle 11 around the pole 1 in order to wind the wire 2 onto the pole 1, and an operation to move the nozzle 11 in the longitudinal direction of the pole 1 in order to feed the wire 2 in the longitudinal direction of the pole 1 by an amount corresponding to the wire diameter. In other words, the wire 2 is wound in a line around the pole 1 by repeating an operation to wind the wire 2 once around the circumference of the pole 1 and then feed the wire 2 in the longitudinal direction of the pole 1 by an amount corresponding to the wire diameter.

The nozzle 11 is moved around the pole 1 by a combination of an operation to move the nozzle 11 in the width direction of the pole 1 and an operation to move the nozzle 11 in the height direction of the pole 1.

More specifically, by driving the winding motor 35, the nozzle 11 oscillates in the width direction of the pole 1 due to the action of the head rotating mechanism 16 and reciprocates in the height direction of the pole 1 due to the action of the head moving mechanism 17. When the oscillation and the reciprocation of the nozzle 11 are combined, the nozzle 11 gyrates in an arc-shaped trajectory around the pole 1.

As described above, when the nozzle 11 oscillates in the width direction of the pole 1, the traverse shaft 14 oscillates in synchronization with the head support shaft 13 due to the action of the shaft connecting device 15. Therefore, the rotation of the traverse shaft 14 does not deviate from the rotation of the head support shaft 13, and as a result, the nozzle 11 does not move in the longitudinal direction of the pole 1, ensuring that winding is performed with stability.

Furthermore, as described above, when the nozzle 11 reciprocates in the height direction of the pole 1, the variable stroke shaft 85 rotates in synchronization with the second rotary shaft 70 due to the action of the shaft connecting device 87. Therefore, the rotation of the cam plate 82 does not deviate from the rotation of the rotary plate 72, and as a result, the stroke of the nozzle 11 in the height direction of the pole 1 does not vary, ensuring that winding is performed with stability.

Thus, the wire 2 can be wound around the pole 1 with stability simply by driving the winding motor 35.

It should be noted that when the nozzle 11 gyrates in an arc-shaped trajectory around the pole 1, the gyration efficiency is not particularly good. This can be corrected by setting the shape of the cam groove 32 on the roller cam 33 such that the nozzle 11 does not move in the width direction of the pole 1 while moving in the height direction of the pole 1, thereby ensuring that the nozzle 11 moves in a straight line in the height direction of the pole 1. Further, by continuously varying the rotation radius of the first cam follower 71 such that the nozzle 11 does not move in the height direction of the pole 1 while moving in the width direction of the pole 1, the nozzle 11 moves in the width direction of the pole 1 at a fixed height. Thus, the nozzle 11 can be moved in a quadrate gyration trajectory around the outer periphery of the pole 1. By making the gyration trajectory of the nozzle 11 quadrate, the gyration efficiency improves, and when the gap between adjacent poles 1 is small, the nozzle 11 can pass through the gap, enabling an improvement in the space factor of the wire 2.

The nozzle 11 is moved in the longitudinal direction of the pole 1 by driving the traverse shaft rotation motor 44 such that the traverse shaft 14 rotates relative to the head support shaft 13. More specifically, by rotating the traverse shaft rotation motor 44 by an angle that corresponds to a feed proportionate to the wire diameter of the wire 2, the nozzle 11 is moved in the longitudinal direction of the pole 1.

When the traverse shaft rotation motor 44 is driven to feed the wire 2 by moving the nozzle 11 in the diametrical direction of the stator 3 while driving the winding motor 35 to wind the wire 2 around the pole 1, the internal gear 26b to which the rotation of the traverse shaft rotation motor 44 is transmitted remains stationary, and therefore, by driving the traverse shaft rotation motor 44, the wire 2 can be fed quickly. In other words, there is no need to rotate the traverse shaft rotation motor 44 in alignment with the rotation speed of the head support shaft 13, and simply by driving the traverse shaft rotation motor 44 from the stationary condition, a rotation speed superimposed on the rotation speed of the traverse shaft 14 when rotating in synchronization with the head support shaft 13 is applied to the traverse shaft 14 such that the traverse shaft 14 rotates relative to the head support shaft 13.

The wire 2 is wound around the pole 1 in multiple layers, and when the stroke of the nozzle 11 in the height direction of the pole 1 needs to be increased or winding is to be performed on poles 1 of different heights, the variable stroke motor 92 is driven to rotate the variable stroke shaft 85 relative to the second rotary shaft 70, thereby modifying the rotation radius of the first cam follower 71.

By controlling the operations of the winding motor 35, traverse shaft rotation motor 44, and variable stroke motor 92 in the manner described above, the wire 2 can be wound onto the pole 1.

According to the embodiment described above, the following effects are exhibited.

When the nozzle 11 is caused to oscillate in the width direction of the pole 1, the traverse shaft 14 rotates in synchronization with the rotation of the head support shaft 13, and therefore no rotational deviation occurs between the two. Further, when the nozzle 11 is moved in the longitudinal direction of the pole 1, it is possible to rotate only the traverse shaft 14, and therefore the traverse shaft 14 can be rotated easily relative to the head support shaft 13. Therefore, the nozzle 11 can be moved easily in the longitudinal direction of the pole 1.

Further, when the nozzle 11 is caused to reciprocate in the height direction of the nozzle 11, the variable stroke shaft 85 rotates in synchronization with the rotation of the second rotary shaft 70, and therefore no rotational deviation occurs between the two. Further, when the stroke of the nozzle 11 in the height direction of the pole 1 is modified, it is possible to rotate only the variable stroke shaft 85, and therefore the variable stroke shaft 85 can be rotated easily relative to the second rotary shaft 70. Hence, the stroke of the nozzle 11 in the height direction of the pole 1 can be modified easily.

Thus, according to the embodiment described above, the wire 2 can be wound around the pole 1 with stability.

Other aspects of this embodiment will now be described.

The shaft connecting device 15 may be constituted in the following manner. In the first gear mechanism 25, the sun gear 25a is fixed non-rotatably, the internal gear 25b is spline-coupled to the head support shaft 13, and the cam follower 31 in the head rotating mechanism 16 is coupled to the internal gear 25b. Further, in the second gear mechanism 26, the rotation of the traverse shaft rotation motor 44 is transmitted to the sun gear 26a, and the internal gear 26b is spline-coupled to the traverse shaft 14. With this constitution, similar actions and effects to those of the embodiment described above can be obtained.

This invention is not limited to the embodiment described above, and may of course be subjected to various modifications within the scope of the technical spirit thereof.

1. A winding apparatus that winds a wire onto a pole, comprising:
a nozzle that unreels the wire;
a nozzle support member that supports the nozzle such that the nozzle is oriented in a longitudinal direction of the pole;
a first shaft that supports the nozzle support member;
a second shaft that is disposed coaxially with the first shaft, rotates about an axial center independently of the first shaft, and is connected to the first shaft in an axial direction;
a nozzle moving plate that is coupled to the second shaft and moves the nozzle in an axial diametrical direction by rotating relative to the nozzle support member;
a shaft connecting device that connects the second shaft to the first shaft such that when the first shaft rotates about the axial center, a rotation thereof is transmitted to the second shaft, but when the second shaft rotates about the axial center, a rotation thereof is not transmitted to the first shaft;
a rotating device that rotates the nozzle support member about the axial center by rotating the first shaft such that the second shaft rotates in synchronization with the first shaft;
a diametrical direction moving device that moves the nozzle in the axial diametrical direction by rotating the second shaft such that the second shaft rotates relative to the first shaft; and
a axial direction moving device that moves the nozzle support member in the axial direction by moving the first shaft and the second shaft in the axial direction.

2. The winding apparatus as defined in claim 1, wherein the shaft connecting device comprise:
a first gear mechanism having a sun gear that is coupled to the first shaft, a ring-shaped internal gear that surrounds the sun gear and is fixed non-rotatably, and a plurality of planetary gears that are disposed between the sun gear and the internal gear and mesh with both the sun gear and the internal gear;
a second gear mechanism having a sun gear that is coupled to the second shaft, a ring-shaped internal gear that surrounds the sun gear, and a plurality of planetary gears that are disposed between the sun gear and the internal gear and mesh with both the sun gear and the internal gear; and
a connecting member that connects the planetary gears of the first gear mechanism and the planetary gears of the second gear mechanism such that the planetary gears of the first gear mechanism and the planetary gears of the second gear mechanism can revolve in synchronization and self-rotate independently of each other,
the rotating device rotate the first shaft by rotating the sun gear of the first gear mechanism, and
the diametrical direction moving device rotate the second shaft by rotating the internal gear of the second gear mechanism.

3. The winding apparatus as defined in claim 1, wherein the shaft connecting device comprise:
a first gear mechanism having a ring-shaped internal gear that is coupled to the first shaft, a sun gear that is surrounded by the internal gear and fixed non-rotatably, and a plurality of planetary gears that are disposed between the internal gear and the sun gear and mesh with both the internal gear and the sun gear;
a second gear mechanism having a ring-shaped internal gear that is coupled to the second shaft, a sun gear that is surrounded by the internal gear, and a plurality of planetary gears that are disposed between the internal gear and the sun gear and mesh with both the internal gear and the sun gear; and
a connecting member that connects the planetary gears of the first gear mechanism and the planetary gears of the second gear mechanism such that the planetary gears of the first gear mechanism and the planetary gears of the second gear mechanism can revolve in synchronization and self-rotate independently of each other,
the rotating device rotate the first shaft by rotating the internal gear of the first gear mechanism, and
the diametrical direction moving device rotate the second shaft by rotating the sun gear of the second gear mechanism.

4. The winding apparatus as defined in claim 3, wherein the rotating device comprise:
a rotation motor;
a roller cam to which a rotation of the rotation motor is transmitted; and
a cam follower that is coupled to the gear to which the first shaft is coupled and guided through a cam groove of the roller cam, and
as the roller cam rotates, the cam follower oscillates to be guided through the cam groove, whereby the first shaft oscillates about the axial center.

5. The winding apparatus as defined in claim 4, wherein the axial direction moving device comprise:
an axial direction movement motor;
a rotary plate to which a rotation of the axial direction movement motor is transmitted, and which has a first cam follower on an outer edge;
a guide rail that extends in the axial direction of the first shaft and the second shaft;
a moving plate that is connected to either one of the first shaft and the second shaft and capable of moving along the guide rail; and
a cam groove that is formed in the moving plate and extends in an orthogonal direction to the guide rail, and
as the rotary plate rotates, the first cam follower is guided through the cam groove, whereby the moving plate reciprocates along the guide rail, and the first shaft and the second shaft reciprocate in the axial direction.

6. The winding apparatus as defined in claim 4, wherein the rotation motor and the axial direction movement motor are constituted by a single motor, and by driving the motor, the nozzle moves around the pole.

7. The winding apparatus as defined in claim 5, wherein the rotary plate comprises:
a sliding plate to which the first cam follower is coupled, and which is capable of moving in a diametrical direction of the rotary plate;
a guide plate that guides the sliding plate; and
a rotation radius modifying device that modifies a rotation radius of the first cam follower by varying a position of the sliding plate, and
by modifying the rotation radius of the first cam follower, a reciprocation stroke of the moving plate along the guide rail is varied and a reciprocation stroke of the first shaft and the second shaft in the axial direction is varied.

8. The winding apparatus as defined in claim 7, wherein the rotation radius modifying device comprise:
a second cam follower coupled to a surface of the sliding plate on an opposite side of a surface to which the first cam follower is coupled; and
a cam plate that is disposed to be capable of rotating concentrically with the rotary plate and formed with a cam groove through which the second cam follower is guided, and
by rotating the cam plate relative to the rotary plate, the second cam follower is guided through the cam groove in the cam plate, and the position of the sliding plate is varied.

9. The winding apparatus as defined in claim 8, wherein the axial direction moving device and the rotation radius modifying device further comprise:
a rotary shaft for transmitting a rotation of the axial direction movement motor to the rotary plate;
a variable stroke shaft coupled to a rotary center of the cam plate;
a variable stroke motor for rotating the variable stroke shaft; and
a shaft connecting device that connects the variable stroke shaft to the rotary shaft such that when the rotary shaft rotates about the axial center, a rotation thereof is transmitted to the variable stroke shaft, but when the variable stroke shaft rotates about the axial center, a rotation thereof is not transmitted to the rotary shaft.

10. The winding apparatus as defined in claim 9, wherein the shaft connecting device comprise:
a first gear mechanism having a sun gear that is coupled to the rotary shaft, a ring-shaped internal gear that surrounds the sun gear and is fixed non-rotatably, and a plurality of planetary gears that are disposed between the sun gear and the internal gear and mesh with both the sun gear and the internal gear;
a second gear mechanism having a sun gear that is coupled to the variable stroke shaft, a ring-shaped internal gear that surrounds the sun gear, and a plurality of planetary gears that are disposed between the sun gear and the internal gear and mesh with both the sun gear and the internal gear; and
a connecting member that connects the planetary gears of the first gear mechanism and the planetary gears of the second gear mechanism such that the planetary gears of the first gear mechanism and the planetary gears of the second gear mechanism can revolve in synchronization and self-rotate independently of each other,
the variable stroke shaft is rotated in synchronization with the rotary shaft by rotating the rotary shaft, and
the variable stroke shaft is rotated relative to the rotary shaft by rotating the variable stroke shaft.

11. The winding apparatus as defined in claim 10, wherein the rotation of the variable stroke motor is transmitted to the internal gear of the second gear mechanism.

12. A winding method for winding a wire onto a pole, comprising:
a nozzle that unreels the wire;
a nozzle support member that supports the nozzle such that the nozzle is oriented in a longitudinal direction of the pole;
a first shaft that supports the nozzle support member;
a second shaft that is disposed coaxially with the first shaft, rotates about an axial center independently of the first shaft, and is connected to the first shaft in an axial direction;
a nozzle moving plate that is coupled to the second shaft and moves the nozzle in an axial diametrical direction by rotating relative to the nozzle support member; and
a shaft connecting device that connects the second shaft to the first shaft such that when the first shaft rotates about the axial center, a rotation thereof is transmitted to the second shaft, but when the second shaft rotates about the axial center, a rotation thereof is not transmitted to the first shaft,
wherein the wire is wound onto the pole by combining:
an operation to rotate the nozzle support member about the axial center by rotating the first shaft such that the second shaft rotates in synchronization with the first shaft;
an operation to move the nozzle in the axial diametrical direction by rotating the second shaft such that the second shaft rotates relative to the first shaft; and
an operation to move the nozzle support member in the axial direction by moving the first shaft and the second shaft in the axial direction.

13. The winding apparatus as defined in claim 2, wherein the rotating device comprise:
a rotation motor;
a roller cam to which a rotation of the rotation motor is transmitted; and
a cam follower that is coupled to the gear to which the first shaft is coupled and guided through a cam groove of the roller cam, and
as the roller cam rotates, the cam follower oscillates to be guided through the cam groove, whereby the first shaft oscillates about the axial center.

14. The winding apparatus as defined in claim 13, wherein the axial direction moving device comprise:
an axial direction movement motor;
a rotary plate to which a rotation of the axial direction movement motor is transmitted, and which has a first cam follower on an outer edge;
a guide rail that extends in the axial direction of the first shaft and the second shaft;
a moving plate that is connected to either one of the first shaft and the second shaft and capable of moving along the guide rail; and
a cam groove that is formed in the moving plate and extends in an orthogonal direction to the guide rail, and
as the rotary plate rotates, the first cam follower is guided through the cam groove, whereby the moving plate reciprocates along the guide rail, and the first shaft and the second shaft reciprocate in the axial direction.

15. The winding apparatus as defined in claim 13, wherein the rotation motor and the axial direction movement motor are constituted by a single motor, and by driving the motor, the nozzle moves around the pole.

16. The winding apparatus as defined in claim 14, wherein the rotary plate comprises:
a sliding plate to which the first cam follower is coupled, and which is capable of moving in a diametrical direction of the rotary plate;
a guide plate that guides the sliding plate; and
a rotation radius modifying device that modifies a rotation radius of the first cam follower by varying a position of the sliding plate, and
by modifying the rotation radius of the first cam follower, a reciprocation stroke of the moving plate along the guide rail is varied and a reciprocation stroke of the first shaft and the second shaft in the axial direction is varied.

17. The winding apparatus as defined in claim 16, wherein the rotation radius modifying device comprise:
a second cam follower coupled to a surface of the sliding plate on an opposite side of a surface to which the first cam follower is coupled; and
a cam plate that is disposed to be capable of rotating concentrically with the rotary plate and formed with a cam groove through which the second cam follower is guided, and
by rotating the cam plate relative to the rotary plate, the second cam follower is guided through the cam groove in the cam plate, and the position of the sliding plate is varied.

18. The winding apparatus as defined in claim 17, wherein the axial direction moving device and the rotation radius modifying device further comprise:
a rotary shaft for transmitting a rotation of the axial direction movement motor to the rotary plate;
a variable stroke shaft coupled to a rotary center of the cam plate;
a variable stroke motor for rotating the variable stroke shaft; and
a shaft connecting device that connects the variable stroke shaft to the rotary shaft such that when the rotary shaft rotates about the axial center, a rotation thereof is transmitted to the variable stroke shaft, but when the variable stroke shaft rotates about the axial center, a rotation thereof is not transmitted to the rotary shaft.

19. The winding apparatus as defined in claim 18, wherein the shaft connecting device comprise:
a first gear mechanism having a sun gear that is coupled to the rotary shaft, a ring-shaped internal gear that surrounds the sun gear and is fixed non-rotatably, and a plurality of planetary gears that are disposed between the sun gear and the internal gear and mesh with both the sun gear and the internal gear;
a second gear mechanism having a sun gear that is coupled to the variable stroke shaft, a ring-shaped internal gear that surrounds the sun gear, and a plurality of planetary gears that are disposed between the sun gear and the internal gear and mesh with both the sun gear and the internal gear; and
a connecting member that connects the planetary gears of the first gear mechanism and the planetary gears of the second gear mechanism such that the planetary gears of the first gear mechanism and the planetary gears of the second gear mechanism can revolve in synchronization and self-rotate independently of each other,
the variable stroke shaft is rotated in synchronization with the rotary shaft by rotating the rotary shaft, and
the variable stroke shaft is rotated relative to the rotary shaft by rotating the variable stroke shaft.

20. The winding apparatus as defined in claim 19, wherein the rotation of the variable stroke motor is transmitted to the internal gear of the second gear mechanism.
